(19) United States
(12) Patent Application Publication
(10) Pub. No.: US 2018/0040860 A1
(43) Pub. Date: Feb. 8, 2018

(54) THIN FILM BATTERY DEVICE AND METHOD OF FORMATION

(71) Applicant: Applied Materials, Inc., Santa Clara, CA (US)

(72) Inventors: Michael Yu-Tak Young, Cupertino, CA (US); Jeffrey L. Franklin, Albuquerque, NM (US)

(21) Appl. No.: 15/338,989

(22) Filed: Oct. 31, 2016

Related U.S. Application Data
(60) Provisional application No. 62/322,415, filed on Apr. 14, 2016.

(51) Int. Cl. H01M 2/02; H01M 4/525; H01M 10/0562; H01M 4/13; H01M 10/0525; H01M 10/0585

(52) U.S. Cl. CPC H01M 2/0267; H01M 10/0525; H01M 10/0585; H01M 10/0562; H01M 4/13; H01M 4/525; H01M 2/0292; H01M 2002/0297

(57) ABSTRACT

A thin film device. The thin film device may include: an active device region; a thin film encapsulant disposed adjacent to the active device region and encapsulating at least a portion of the active device region. The thin film encapsulant may include an outer layer, wherein the outer layer is disposed adjacent ambient and comprises a hydrophobic layer.

### RELATED APPLICATIONS

This Application claims priority to U.S. provisional patent application No. 62/322,415, filed Apr. 14, 2016, entitled Volume Change Accommodating TFE Materials, and incorporated by reference herein in its entirety.

### FIELD

The present embodiments relate to thin film encapsulation (TFE) technology used to protect active devices, and more particularly to encapsulating thin film battery devices.

### BACKGROUND

Encapsulation of devices such as thin film devices may be used to protect active devices from exposure to ambient conditions. Lithium ion batteries, as an example, may be fabricated as thin film devices, where active device regions are encapsulated for protection. In particular, lithium ion batteries are highly sensitive to moisture and accordingly need protection from ambient moisture to function properly over time. Otherwise, upon moisture exposure, a battery cell can have the exposed lithium material of the battery cell react with ambient moisture, leading to a reduced cell capacity if the lithium reservoir is not adequate. The attack by ambient moisture can also lead to degraded cell performance.

With respect to these and other considerations the present disclosure is provided.

### BRIEF SUMMARY

In one embodiment, a thin film device may include: an active device region; a thin film encapsulant disposed adjacent to the active device region and encapsulating at least a portion of the active device region. The thin film encapsulant may include an outer layer, wherein the outer layer is disposed adjacent ambient and comprises a hydrophobic layer.

In a further embodiment, a thin film battery may include a lithium-containing cathode; a solid state electrolyte disposed on the lithium-containing cathode; an anode region disposed on the solid state electrode; and a thin film encapsulant disposed over the anode region. The thin film encapsulant may include at least one polymer layer; at least one rigid dielectric layer disposed adjacent the at least one polymer layer; and an outer layer, wherein the outer layer is disposed adjacent ambient and comprises a hydrophobic layer.

In another embodiment, a method of forming a thin film device may include forming an active device region on a substrate, where the active device region comprises a water sensitive material. The method may further comprise forming a thin film encapsulant on the active device region, wherein the thin film encapsulant comprises a plurality of layers, wherein an outer layer of the thin film encapsulant is disposed adjacent ambient and comprises a hydrophobic layer.

### BRIEF DESCRIPTION OF THE DRAWINGS

FIG. 1 shows a thin film device arranged according to embodiments of the disclosure;

FIG. 2 shows a thin film device according to further embodiments of the disclosure;

FIG. 3 illustrates a particular embodiment of a thin film battery;

FIG. 4 depicts a thin film battery in accordance with further embodiments of the disclosure;

FIG. 5 presents a detailed view of a thin film encapsulant according to embodiments of the disclosure; and

FIG. 6 presents an exemplary process flow according to embodiments of the disclosure.

### DETAILED DESCRIPTION

The present embodiments will now be described more fully hereinafter with reference to the accompanying drawings, where some embodiments are shown. The subject matter of the present disclosure may be embodied in many different forms and are not to be construed as limited to the embodiments set forth herein. These embodiments are provided so this disclosure will be thorough and complete, and will fully convey the scope of the subject matter to those skilled in the art. In the drawings, like numbers refer to like elements throughout.

The present embodiments are related to thin film encapsulation (TFE) technology, where a thin film encapsulant is used to minimize ambient exposure of active devices. The present embodiments provide novel structures and materials combinations for thin film encapsulation.

Examples of active devices include electrochemical devices such as electrochromic windows and thin film batteries, and other electrical devices where active component materials of such devices are highly sensitive/reactive to moisture or other ambient materials. To this end, known devices including thin film batteries may be provided with encapsulation to protect the active component materials.

In various embodiments of the disclosure, a thin film device may include an active device region and a thin film encapsulant. The thin film encapsulant may include a stack of layers formed from at least one layer, where an outer layer, or final layer, of the thin film encapsulant is hydrophobic in nature. Accordingly, the thin film device may have superior performance or may have more robust characteristics because of the increased protection from moisture attack. In some embodiments, the thin film device may be a thin film battery, including, among other features, a lithium-containing cathode; a solid state electrolyte disposed on the lithium-containing cathode; and an anode region disposed on the solid state electrode, where the anode region is disposed adjacent the thin film encapsulant. By providing an improved thin film encapsulant, the present embodiments better protect such components of a thin film battery, especially those components sensitive to attack from moisture.

As detailed below, in some embodiments a thin film encapsulant may include a plurality of layers, where the plurality of layers comprises at least one rigid layer, such as a rigid dielectric layer or rigid metal layer, and at least one polymer layer, where the outermost layer (outer layer) facing the ambient is a hydrophobic layer. In other words, an outermost layer adjacent ambient conditions outside the thin film encapsulant is formed from a hydrophobic material. As used herein, the term “hydrophobic layer” refers to a layer repelling water, either by virtue of the chemical nature, by virtue of the physical structure, especially the surface structure, or by a combination of chemical nature and physical structure of the layer. As used herein, the term “hydrophobic material” refers to a material or substance repelling water due to the chemical nature of the material. For example, in the case of polymers, as is well known, polyvinyl alcohol or polymethylmethacrylate may not be deemed hydrophobic, while a fluoropolymer such as polytetrafluoroethylene (PTFE) or a polymer such as polypropylene are hydrophobic. Other examples of non-hydrophobic materials include silicon nitride and soda lime glass. Accordingly, a layer of material composed of PFTE may be deemed hydrophobic independent of the physical structure of the layer. More particularly, a material or a layer generating a contact angle with water of greater than 90 degrees may be deemed a hydrophobic material or hydrophobic layer.

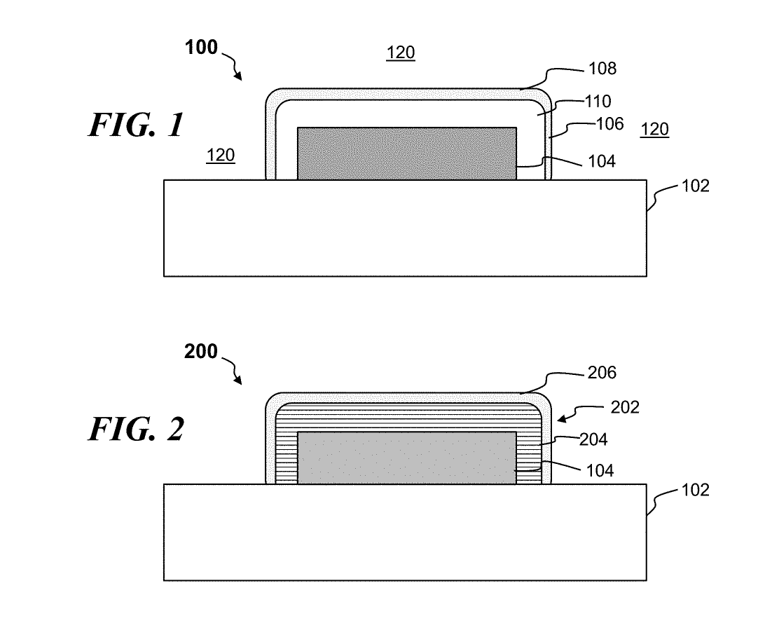

Turning now to the figures, in FIG. 1 there is shown a thin film device 100 arranged according to embodiments of the disclosure. In some embodiments, the thin film device 100 may be a thin film battery, an electrochromic window, or any other device containing moisture sensitive material. Thin film device 100 may include a substrate base 102, which base may be any target material depending upon the exact device being formed, including a ceramic, a semiconductor, or a polymer, for example. The thin film device 100 may further include an active device region 104, shown as a block in this schematic representation. The active device region 104 may represent multiple components depending upon the type of device represented by thin film device 100. During operation, the active device region 104 may perform functions according to the target application, such as the charging and discharging of a battery, the reversible change in light transmission in an electrochromic window, or performing other functions associated with other active devices.

The thin film device 100 may further include a thin film encapsulant 106, disposed over the active device region 104, and encapsulating the active device region 104 as shown. In accordance with the present embodiments, the thin film encapsulant 106 may include an outer layer 108, where the outer layer 108 is a hydrophobic layer. According to various embodiments, the thin film encapsulant 106 may include an inner region 110, where the inner region 110 includes at least one layer. In various embodiments, the composition and structure of the inner region 110 may differ from the outer layer 108.

During use, the thin film device 100 may operate in an ambient 120, such as a liquid ambient or a gas phase ambient, such as air, where the ambient 120 contains liquid water, water vapor, or a combination of the two. The water in ambient 120 may condense upon the thin film device 100. Because the outer layer 108 is a hydrophobic layer, the water may be repelled and may tend to form droplets not wetting the surface of thin film encapsulant 106. In this manner, the water may be less likely to penetrate into the thin film encapsulant 106 and to attack the active device region 104, leading to better performance and longer life of the thin film device 100.

Turning now to FIG. 2 there is shown a thin film device 200 according to further embodiments of the disclosure. The thin film device 200 may include some components the same as those in thin film device 200, where like components are labeled the same. The thin film device 200 may include a thin film encapsulant 202, where the thin film encapsulant 202 is arranged as a stack of layers, including an outer layer 206 and a plurality of inner layers, shown as inner layers 204. The outer layer 206 may be a hydrophobic layer as discussed above with respect to FIG. 1. In various embodiments, the plurality of inner layers forming the inner layers 204 of the thin film encapsulant may include at least one inner layer where the at least one inner layer is a non-hydrophobic layer.

In particular, non-limiting embodiments, the thin film encapsulant 202 may be arranged as a stack of layers where the inner layers 204 may include at least one polymer layer and at least one rigid layer. A suitable rigid layer may be a rigid dielectric layer or rigid metal layer, where the rigid layer is disposed adjacent the at least one polymer layer. In some embodiments, a polymer layer and rigid dielectric layer may form a dyad where the inner layers 204 include at least one dyad. The at least one polymer layer and rigid dielectric layer may serve different functions. For example, in embodiments where the thin film device 200 is a thin film battery, the at least one polymer layer may be a soft and pliable layer arranged to elastically deform to accommodate displacements in the active device region 104 caused when the thin film battery charges and discharges. In such circumstances, material such as lithium ions may be transported between anode regions and cathode, causing local changes in volume of the active device region. The rigid layer, such as silicon nitride or a metal, such as Cu, Al, Pt, Au, or other metal, may be useful to prevent diffusion or permeation of species through the thin film encapsulant 202. The outer layer 206 in turn may act to prevent, retard, or reduce water penetration into thin film encapsulant 202 and active device region 104 by repelling water.

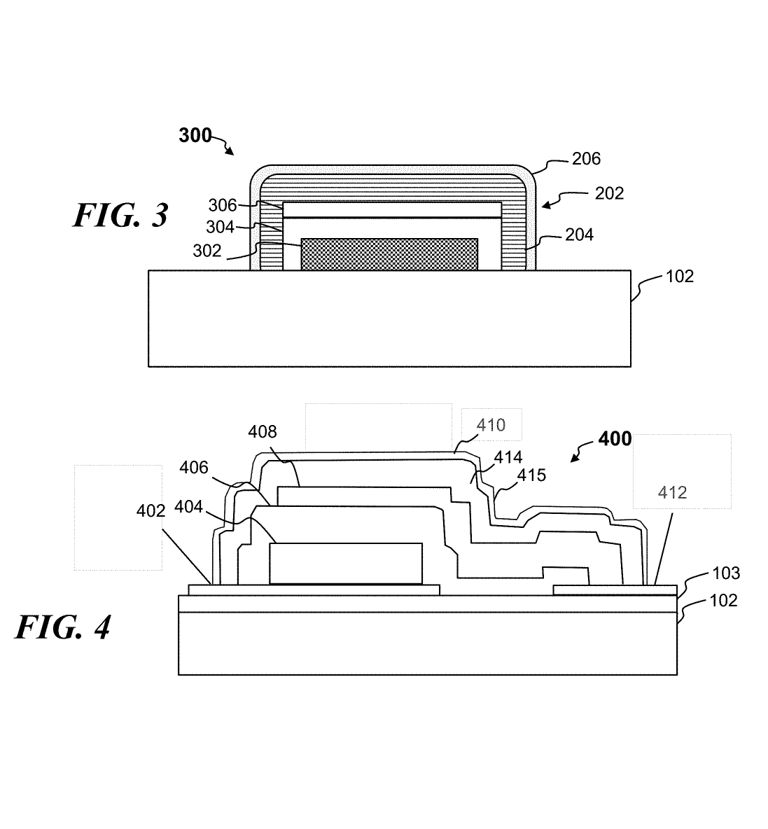

FIG. 3 illustrates a particular embodiment of a thin film battery 300, where the thin film battery includes a cathode 302, solid state electrolyte 304, and anode region 306, among other features. Notably, the thin film battery 300 may include other features not shown, such as a cathode current collector, as will be appreciated by those of skill in the art. The cathode 302 may be a lithium-containing cathode, such as LiCoO₂ or similar material. The solid state electrolyte 304 may be a lithium phosphorus oxynitride (LiPON), or other known material for transporting a diffusant between anode region and cathode.

The cathode 302, solid state electrolyte 304 and anode region 306 may constitute an active device region, where the active device region is encapsulated by the thin film encapsulant 202 as discussed above. Notably, the thin film encapsulant 202 may be disposed over the anode region 306 as shown. In operation, the thin film battery 300 may reversibly charge and discharge multiple times. In embodiments where the thin film battery 300 is a lithium battery, lithium may be reversibly transported between the cathode 302 and anode region 306 during charging and discharging. Regions of thin film battery 300 containing lithium or lithium compounds may be particularly susceptible to degradation by reaction with water. Accordingly, the provision of the outer layer 206 may reduce the attack on the active device region of thin film battery 300, in comparison to known thin film batteries not equipped with a hydrophobic layer arranged as the outer layer.

FIG. 4 depicts a thin film battery 400 in accordance with further embodiments of the disclosure. As illustrated, the thin film battery 400 includes a substrate base 102, intermediate layer 103, cathode current collector 402, cathode 404, solid state electrolyte 406, anode region 408, and anode current collector 412, among other features. The thin film battery 400 may be formed by a combination of deposition techniques and lithography/etching so as to form the planar device as shown, where the anode current collector 412 and cathode current collector 402 are coplanar. In some examples the layers of the thin film battery 400 may be etched to form the structure shown by a maskless process, such as laser etching to remove material of layers initially deposited in blanket form. In other embodiments the anode current collector 412 and cathode current collector 402 may be non-coplanar. As illustrated, the thin film battery 400 includes a thin film encapsulant 410, including inner layers 414 (not individually shown) and outer layer 415, where the outer layer 415 is a hydrophobic layer and acts to repel water as discussed above. The thin film encapsulant 410 may conformally cover the active device region of the thin film battery 400 including cathode 404, solid state electrolyte 406, and anode region 408.

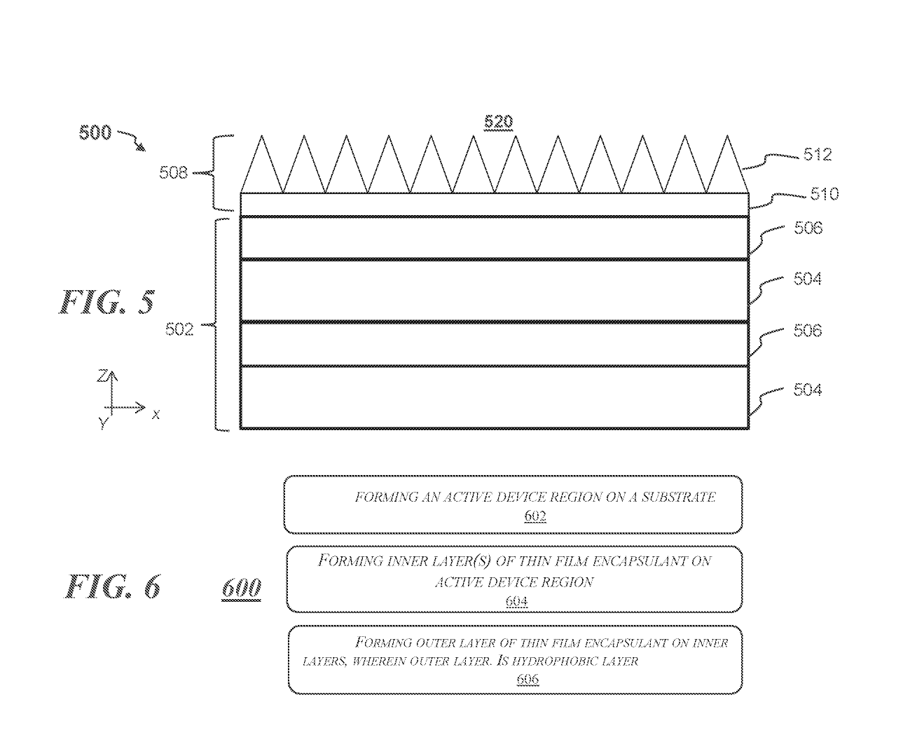

As discussed previously, in some embodiments an outer layer may be formed as a hydrophobic layer by engineering the physical structure of the outer layer to generate a hydrophobic quality to the outer layer. FIG. 5 presents a detailed view of a thin film encapsulant 500 according to embodiments of the disclosure. In some embodiments the thin film encapsulant 500 may be a variant of the thin film encapsulant 106, thin film encapsulant 202, or thin film encapsulant 410, for example. The embodiments are not limited in this context. The thin film encapsulant 500 may include inner layers 502, where the inner layers 502 are formed by at least one dyad, where a dyad is formed from a polymer layer 504 and a rigid layer 506, where the rigid layer 506 may be a rigid dielectric layer or rigid metal layer. In the example illustrated, two dyads are formed in the inner layers 502. The thin film encapsulant 500 further includes an outer layer 508. The outer layer 508 may be formed of any convenient material such as a polymer, an oxide, a nitride, or other material.

A hallmark of the outer layer 508 is the provision of a surface-engineered layer, where the outer surface of the outer layer 508, facing ambient 520, is a non-planar outer surface. In particular, the outer layer 508 may comprise a plurality of surface features, shown as surface features 512. In various embodiments the surface features 512 may have a size and shape generating a hydrophobic nature to the outer layer 508. The surface features 512 may have a conical shape, a prolate spheroid shape, a columnar shape, or other known shape in various embodiments. The embodiments are not limited in this context. In some embodiments, the surface features 512 may be formed by a surface engineering process, where surface patterning of the outer layer 508 is performed. In some embodiments surface patterning may be performed by known patterning processes including lithographic patterning and etching to form small features within the portions of outer layer 508 remaining after the general device shape of the thin film encapsulant 500 is formed. Alternatively, laser micromachining, or other surface-engineering process may be used to generate the surface features 512. In some embodiments, the outer layer 508 may have a thickness of 1 micrometer to 20 micrometers. The embodiments are not limited in this context. In some embodiments, the surface features 512 may have a feature height of between one hundred nanometers and twenty micrometers. In some embodiments the outer layer 508 may, but need not, include a portion 510 where the portion 510 is not patterned. The embodiments are not limited in this context. The aspect ratio of surface features 512, meaning ratio of height along the Z-axis to width in the X-Y plane of the Cartesian coordinate system shown, may also be chosen to impart a hydrophobic surface. In some embodiments the aspect ratio of surface features 512 may vary between 0.2 and 10. The embodiments are not limited in this context.

In particular embodiments, the surface features may be engineered to mimic known hydrophobic or super-hydrophobic materials. As used herein the term “super-hydrophobic” may refer to a material or surface or layer generating a contact angle with water of at least 150 degrees. As an example, some plants exhibit contact angles up to 160° with respect to water, where just 2-3% of the surface of a droplet (of common size) is in contact with the surface of the plant. Some plants having a double structured surface such as the lotus leaf may have a contact angle of 170°, where the water droplet's contact area is just 0.6%. Accordingly, in particular embodiments of the disclosure, the structure of the surface features 512 may be engineered to mimic a lotus leaf or similar structure, for example, by micromachining. This engineering may accordingly impart a low surface energy to the outer layer 508, meaning the outer layer 508 is hydrophobic or super-hydrophobic.

As noted previously, an outer layer, such as outer layer 508, while having patterned features surface engineered to impart hydrophobic qualities, may additionally constitute a hydrophobic material, such as polytetrafluoroethylene in one example. This combination of physical structure and chemical nature may impart a relatively stronger hydrophobic nature to outer layer 508.

While the aforementioned embodiments focus on thin film encapsulants including an outer layer and inner layers, in other embodiments a thin film encapsulant may simply constitute an outer layer, where the outer layer is hydrophobic. An advantage of providing an outer layer as a hydrophobic layer is the ability to prevent water or moisture from beginning to attack a thin film encapsulant. Accordingly, the number of inner layers or overall thickness of a thin film encapsulant protecting an active device region may be reduced because water is less likely to penetrate into the thin film encapsulant.

FIG. 6 presents an exemplary process 600 flow according to embodiments of the disclosure. At block 602 an active device region is formed on a substrate. The active device region may constitute various components of a thin film device, such as a cathode, electrolyte and anode region in the case of a thin film battery. The active device region may be formed, for example, by a combination of depositing layers and patterning the layers.

At block 604, inner layer(s) of a thin film encapsulant are formed on the active device region. The inner layers may also be formed by a combination of deposition and lithography/etching in some embodiments. The inner layers may comprise at least one layer designed to reduce diffusion of materials from ambient to the active device region or to accommodate volume expansion of the active device region, among other functions. In some embodiments the inner layers may be formed of non-hydrophobic materials, such as silicon nitride, or certain polymeric materials. The embodiments are not limited in this context.

At block 606 an outer layer of the thin film encapsulant is formed on the inner layers, wherein the outer layer is a hydrophobic layer. In various embodiments the outer layer may be formed of a hydrophobic material. In some embodiments, the outer layer may be deposited as a blanket layer, etched to from a structure as part of a stack of layers in a thin film encapsulant, and patterned on the surface in a manner so as to form a surface-engineered structure. The surface-engineered structure may include a plurality of microscopic features imparting hydrophobic qualities due to the structure of the microscopic features. In particular embodiments, the microscopic features may be formed by laser surface micromachining to have a low surface energy and hydrophobic or super-hydrophobic characteristics. The embodiments are not limited in this context.

There are multiple advantages provided by the present embodiments, including the advantages afforded by the ability to reduce the thickness of non-active thin film encapsulants used in a thin film device, leading to enhanced energy density of these devices. A further advantage is the improved robustness of a thin film encapsulant provided by preventing or limiting initial tendency of water to penetrate into a thin film encapsulant.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, the present disclosure has been described herein in the context of a particular implementation in a particular environment for a particular purpose, while those of ordinary skill in the art will recognize the usefulness is not limited thereto and the present disclosure may be beneficially implemented in any number of environments for any number of purposes. Thus, the claims set forth below are to be construed in view of the full breadth and spirit of the present disclosure as described herein.

What is claimed is:

1. A thin film device, comprising:
an active device region; and
a thin film encapsulant disposed adjacent to the active device region and encapsulating at least a portion of the active device region, the thin film encapsulant comprising:
an outer layer, wherein the outer layer is disposed adjacent ambient and comprises a hydrophobic layer.

2. The thin film device of claim 1, wherein the thin film device comprises a thin film battery, wherein the active device region comprises:
a lithium-containing cathode;
a solid state electrolyte disposed on the lithium-containing cathode; and
an anode region disposed on the solid state electrolyte, the anode region being further disposed adjacent the thin film encapsulant.

3. The thin film device of claim 1, wherein the thin film encapsulant comprises a plurality of layers, wherein the plurality of layers comprises at least one rigid dielectric layer and at least one polymer layer.

4. The thin film device of claim 1, wherein the outer layer comprises a hydrophobic material, the outer layer generating a contact angle with water of greater than 90 degrees.

5. The thin film device of claim 4, wherein the outer layer comprises a fluoropolymer.

6. The thin film device of claim 1, wherein the outer layer comprises a surface-engineered layer, wherein the surface-engineered layer comprises a non-planar outer surface.

7. The thin film device of claim 6, wherein the surface-engineered layer comprises a plurality of surface features, the plurality of surface features having a feature height of between one hundred nanometers and twenty micrometers.

8. The thin film device of claim 6, the surface-engineered layer generating a contact angle of at least 150 degrees.

9. The thin film device of claim 6, wherein the outer layer comprises a hydrophobic material.

10. The thin film device of claim 1, wherein the thin film encapsulant comprises a plurality of layers, wherein at least one inner layer of the thin film encapsulant is a non-hydrophobic layer.

11. The thin film device of claim 1, wherein the outer layer comprises a thickness of 1 micrometer to 20 micrometers.

12. A thin film battery, comprising:
a lithium-containing cathode;
a solid state electrolyte disposed on the lithium-containing cathode;
an anode region disposed on the solid state electrolyte; and
a thin film encapsulant, the thin film encapsulant disposed over the anode region and comprising:
at least one polymer layer;
at least one rigid layer disposed adjacent the at least one polymer layer; and
an outer layer, wherein the outer layer is disposed adjacent ambient and comprises a hydrophobic layer.

13. The thin film battery of claim 12, wherein the outer layer comprises a hydrophobic material, the outer layer generating a contact angle with water of greater than 90 degrees, and wherein the at least one polymer layer and the at least one rigid layer are not hydrophobic.

14. The thin film battery of claim 12, wherein the outer layer comprises a surface-engineered layer, wherein the surface-engineered layer comprises a non-planar outer surface, the surface-engineered layer generating a contact angle with water of greater than 90 degrees.

15. The thin film battery of claim 14, wherein the surface-engineered layer comprises a plurality of surface features, the plurality of surface features having a feature height of between one hundred nanometers and twenty micrometers.

16. A method of forming a thin film device, comprising:
forming an active device region on a substrate, the active device region comprising a water sensitive material; and
forming a thin film encapsulant on the active device region, wherein the thin film encapsulant comprises a plurality of layers, wherein an outer layer of the thin film encapsulant is disposed adjacent ambient and comprises a hydrophobic layer.

17. The method of claim 16, wherein the thin film device comprises a thin film battery, wherein the forming the active device region comprises:
forming a lithium-containing cathode;
forming a solid state electrolyte on the lithium-containing cathode; and
forming an anode region on the solid state electrolyte, the anode region being further disposed adjacent the thin film encapsulant.

18. The method of claim 16, wherein the forming the outer layer comprises patterning an outer surface of the outer layer, wherein the outer surface generates a contact angle with water of greater than 90 degrees.

19. The method of claim 18, wherein the patterning comprises laser micromachining the outer surface to generate a plurality of surface features, wherein the plurality of surface features comprises a feature height of between one hundred nanometers and twenty micrometers.

20. The method of claim 16, wherein the outer layer comprises a hydrophobic material.
